(19) United States
(12) Patent Application Publication
(10) Pub. No.: US 2006/0040824 A1
(43) Pub. Date: Feb. 23, 2006

(54) Nitrogen oxides-removing material and device

(75) Inventors: Shinichi Ikeda, Tsukuba-shi (JP); Norio Umeyama, Tsukuba-shi (JP); Hideo Abe, Yokohama-shi (JP); Yasuhito Tanaka, Yokohama-shi (JP); Ariyoshi Ogasawara, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: SFC CO., LTD., Yokohama-shi (JP)

(21) Appl. No.: 11/207,796

(22) Filed: Aug. 22, 2005

(30) Foreign Application Priority Data
Aug. 23, 2004 (JP) 2004-242125

(51) Int. Cl. B01J 23/86; B01J 20/00

(52) U.S. Cl. 502/400; 502/315; 502/406

(57) ABSTRACT

A nitrogen oxides-removing material has fixed onto surfaces of metal fibers a complex compound containing at least one element selected from the group consisting of Group VIII elements, Group IX elements and Group X elements in the periodic table of the elements and at least one element selected from the group consisting of Group I elements, Group II elements, Group XIII elements and Group XIV elements in the periodic table of the elements. A nitrogen oxides-removing device includes the nitrogen oxides-removing material and a means to elevate a temperature of the nitrogen oxides-removing material to than 100° C. or more.

### BACKGROUND OF THE INVENTION

1. Field of the Invention

This invention relates to a material and a device for removing nitrogen oxides (NOₓ) which are present in the gas discharged from an internal combustion engine, such as an automobile engine, or from an industrial plant, and more particularly to the technology for removing the NOₓ in the exhaust gas without using a reducing agent, such as ammonia.

1. Description of the Prior Art

The exhaust gases of combustion discharged from the automobiles and the marine structures which have an internal combustion engine as a source of actuation or from the blasting furnaces, incinerators, thermal power plants and crude oil refineries which produce hot environments by burning substances never fail to form nitrogen oxides in the air without reference to their sizes of volume.

The methods which are directed toward diminishing the amounts of NOₓ to be discharged are broadly classified into two kinds, (1) the methods which remove the NOₓ formed in the exhaust gases and (2) the methods which suppress the formation of NOₓ by improving the technique of combustion. The methods of (1) comprise a dry method and a wet method. The dry method consists in reducing the NOₓ thereby detoxifying it. The wet method consists in detoxifying the NOₓ by mainly causing it to be absorbed in a liquid and consequently converted into by-produced nitrates. The wet method has been enjoying an advanced research mainly in the removal of the NOₓ in boilers and heating furnaces. In contrast, the dry method has encouraged the advance of a research regarding the treatment of the NOₓ in the exhaust gas from an automobile, for example, because this method does not give rise to any by-product and is effective for a mobile source of generation or a small source of generation.

In this dry method, particularly the version which is called the catalytic reduction method has been renowned. This method comprises adding a reducing gas, such as methane, carbon monoxide or ammonia, to the gas containing NO or NO₂ and reducing the NO₂ to NO and this NO to a harmless N₂ by a catalytic action. This catalytic reduction method is known in two kinds, the selective catalytic reduction process and the non-selective catalytic reduction process. When a gas containing NOₓ adds ammonia as a reducing agent and undergoes the action of a Pt catalyst at 200 to 300° C., for example, the NOₓ in the gas is selectively reduced to N₂. As a concrete example, the method of ammonia selective reduction (SCR method) using an oxide-based catalyst, such as V₂O₅+TiO₂, has been already adopted actually for the exhaust gas from a large boiler of a thermal power plant.

In these circumstances, the research aimed at detoxifying the nitrogen oxides in the exhaust gas from a gasoline engine using gasoline as a fuel is being pursued energetically using a precious metal catalyst. As regards the suppression of the nitrogen oxides, for example, the technique of reducing the nitrogen oxides, NOₓ, formed from the nitrogen and the oxygen in the air by the high-temperature combustion in the engine up to nitrogen by using a catalyst called a ternary catalyst developed for treating the exhaust gas of an automobile equipped with a gasoline engine and also using the unburned hydrocarbon and carbon monoxide in the exhaust gas as a reducing agent has been finding extensive utility. The ternary catalyst is a catalyst which is obtained by having noble metals, such as Pt, Pd and Rh, deposited as dispersed in the form of ultrafine particles on the surface of an alumina substrate and mounting the substrate carrying the noble metals on a refractory ceramic base. Incidentally, the term “ternary” used herein means capable of simultaneous removal of hydrocarbon, carbon monoxide and nitrogen oxides. When the ternary catalyst is used in the presence of excess oxygen, the catalytic effect is markedly suppressed and the reduction of NOₓ is obtained only with difficulty.

By the catalytic reduction processes mentioned above, however, the NOₓ will not be effectively detoxified unless the reducing agent and the catalyst, such as Pt, are both present constantly. Since the exhaust gas of lean-burn according to the method of highly efficient combustion (the exhaust gas of a gas turbine, a diesel engine or a lean-burn gasoline engine) contains a large amount of oxygen, it does not allow application of the method of ternary catalyst which is a non-selective catalytic reduction process.

JP-A 2001-73745 discloses an exhaust gas purifying system which consists in using a catalyst for removing with high efficiency the nitrogen oxides in a lean-burn exhaust gas containing oxygen excessively. The exhaust gas purifying system has disposed in the exhaust gas passageway of an internal combustion engine or a combustion device a NOₓ removing catalyst for giving a reducing treatment to the NOₓ with a reducing agent and an exhaust gas composition adjusting means for forming a low hydrocarbon reduced gas having the concentration of the hydrocarbon (HC) decreased in the neighborhood of a theoretical air-fuel ratio and in an atmosphere of excess oxygen. The exhaust gas composition adjusting means is disposed on the upstream side of the NOₓ removing catalyst in the exhaust gas passageway. Even the invention which is disclosed in JP-A 2001-73745, however, is not different from the conventional catalytic reduction method in respect that it essentially necessitates a low HC reduced gas as the reducing agent.

This invention has for an object thereof the provision of a material suitable for removing nitrogen oxides without requiring use of a reducing agent, such as HC gas or ammonia, and a nitrogen oxides-removing device formed of this material.

### SUMMARY OF THE INVENTION

A first aspect of the invention provides a nitrogen oxides-removing material having fixed onto surfaces of metal fibers a complex compound containing at least one element selected from the group consisting of Group VIII elements, Group IX elements and Group X elements in the periodic table of the elements and at least one element selected from the group consisting of Group I elements, Group II elements, Group XIII elements and Group XIV elements in the periodic table of the elements.

A second aspect of the invention provides the nitrogen oxides-removing material according to the first aspect of the invention, wherein the complex compound contains at least one element selected from the group consisting of Group VIII elements, Group IX elements and Group X elements in the periodic table of the elements, at least one of Group I elements in the periodic table of the elements, at least one of Group II elements in the periodic table of the elements, at least one of Group XIII elements in the periodic table of the elements and at least one of Group XIV elements in the periodic table of the elements.

A third aspect of the invention provides a nitrogen oxides-removing device comprising the nitrogen oxides-removing material of the first or second aspect of the invention and a temperature elevating means for elevating a temperature of the nitrogen oxides-removing material to 100° C. or more.

A fourth aspect of the invention provides a nitrogen oxides-removing device having disposed on an upstream side of the nitrogen oxides-removing material of the first or second aspect of the invention a means to decrease a concentration of oxygen contained in an exhaust gas of combustion being introduced into the nitrogen oxides-removing device of the first or second aspect of the invention.

The nitrogen oxides-removing material of this invention and the nitrogen oxides-removing device using the nitrogen oxides-removing material can obviate the necessity for a plant unit intended to introduce a reducing agent and maintain an excellent removing performance for a long time at a low cost because they are capable of thoroughly removing the nitrogen oxides without using a reducing agent, such as an HC gas or ammonia.

Further, the nitrogen oxides-removing device of this invention is provided with a means to elevate the temperature of the nitrogen oxides-removing material to 100° C. or more. Even when the effect of removing the nitrogen oxides is lowered, therefore, the function of removing the nitrogen oxides can be recovered by heating the nitrogen oxides-removing material.

Furthermore, the nitrogen oxides-removing device of this invention has disposed on the upstream side of the nitrogen oxides-removing material mentioned above the means to lower the concentration of oxygen contained in the exhaust gas of combustion being introduced into the nitrogen oxides-removing device. Even when the exhaust gas happens to contain oxygen excessively, therefore, the device is highly effective in removing the nitrogen oxides contained in the gas and detoxifying the gas.

The above and other objects, characteristic features and advantages of the present invention will become apparent to those skilled in the art from the description made herein below with reference to the accompanying drawings.

### BRIEF EXPLANATION OF THE DRAWING

FIG. 1 is a general schematic diagram of an evaluating system 1 used in performing Test 1 for evaluating the removal of nitrogen oxides with respect to Example 1 and Comparative Example 1.

FIG. 2 is a graph showing the results of Test 1 for evaluating the removal of nitrogen oxides with respect to Example 1.

FIG. 3 shows the results of the measurement by X-ray diffraction of a complex compound forming the nitrogen oxides-removing material of Example 1.

FIG. 4 is a graph showing the results of Test 1 for evaluating the removal of nitrogen oxides with respect to Comparative Example 1.

FIG. 5 is a graph showing the results of Test 2 for evaluating the removal of nitrogen oxides with respect to Example 1.

FIG. 6 is a graph showing the results of Test 2 for evaluating the removal of nitrogen oxides with respect to Example 2.

FIG. 7 is a graph showing the results of Test 2 for evaluating the removal of nitrogen oxides with respect to Example 3.

FIG. 8 is a graph showing the results of Test 2 for evaluating the removal of nitrogen oxides with respect to Example 4.

FIG. 9 is a graph showing the results of Test 2 for evaluating the removal of nitrogen oxides with respect to comparative Example 2.

FIG. 10 is a graph showing the results of a test for evaluating the removal of nitrogen oxides when the nitrogen oxides-removing material of Example 1 was used in combination with a Ti-fixed filter material with respect to a combustion gas containing oxygen.

FIG. 11 is a graph showing the results of a test for evaluating the removal of nitrogen oxides when the nitrogen oxides-removing material of Example 1 was used alone with respect to a combustion gas containing oxygen.

FIG. 12 is a graph showing the results of a test of the nitrogen oxides-removing device of Example 5 for evaluating the removal of nitrogen oxides with respect to a combustion gas containing oxygen.

### DESCRIPTION OF THE PREFERRED EMBODIMENT

The nitrogen oxides-removing material contemplated by this invention is produced by fixing onto the surfaces of metal fibers a complex compound containing at least one element selected from the group consisting of Group VIII elements, Group IX elements and Group X elements in the periodic table of the elements and at least one element selected from the group consisting of Group I elements, Group II elements, Group XIII elements and Group XIV elements in the periodic table of the elements. As concrete examples of Group VIII elements which are usable in this invention, ruthenium (Ru) and iron (Fe) may be cited. As concrete examples of Group IX elements, cobalt (Co), rhodium (Rh) and iridium (Ir) may be cited. As concrete examples of the Group X elements, nickel (Ni), palladium (Pa) and platinum (Pt) may be cited. The complex oxide to be fixed onto the surfaces of metal fibers is preferred to contain at least one of these elements. In this invention, the total content of the elements mentioned above is preferred to be in the range of 0.1 to 50 weight % of the complex oxide to be fixed onto the surfaces of metal fibers.

As Group I elements in the periodic table of the elements, lithium (Li), sodium (Na), potassium (K), rubidium (Rb) and cesium (Cs) are cited. The complex oxide to be fixed onto the surfaces of metal fibers is preferred to contain at least one of Group I elements. In this invention, the total content of Group I elements is preferred to be in the range of 0.1 to 30 weight %.

As Group II elements in the periodic table of the elements to be used in this invention, beryllium (Be), magnesium (Mg), calcium (Ca), strontium (Sr) and barium (Ba) are cited. At least one of Group II elements is preferred to be contained. In this invention, the total content of Group II elements is preferred to be in the range of 0.1 to 30 weight % of the complex oxide to be fixed onto the surfaces of metal fibers.

As Group XIII elements in the periodic table of the elements to be used in this invention, boron (B), aluminum (Al), gallium (Ga) and indium (In) are cited. The complex oxide to be fixed onto the surfaces of fibers contains at least one of Group XIII elements. Then, in the present invention, the total content of Group XIII elements is preferred to be in the range of 0.1 to 30 weight % of the complex oxide to be fixed onto the surfaces of metal fibers.

As Group XIV elements in the periodic table of the elements to be used in this invention, carbon (C), silicon (Si), tin (Sn) and lead (Pb) are cited. The complex oxide to be fixed onto the surfaces of metal fibers contains at least one of Group XIV elements. In this invention, the total content of Group XIV elements is preferred to be in the range of 0.1 to 30 weight % of the complex oxide to be fixed onto the surfaces of metal fibers.

Thus, in the nitrogen oxides-removing material of this invention, the complex compound which is an essential component substance is preferred to contain at least one element selected from the group consisting of Group VIII elements, Group IX elements and Group X elements in the periodic table of the elements, at least one element of Group I elements in the periodic table of the elements, at least one element of Group II elements in the periodic table of the elements, at least one element of Group XIII elements in the periodic table of the elements, and at least one element of Group XIV elements in the periodic table of the elements. The complex oxide is preferably prepared so that the total content of these elements falls in the range of composition mentioned above.

The complex compound of which the nitrogen oxides-removing material of this invention is formed can be manufactured by a varying method. The selected element from Group VIII element, Group IX elements and Group X elements, Group I element, Group II element, Group XIII element, and Group XIV element are prepared each in the form of oxide, nitrate, sulfate or carbonate and converted into slurry or a solution such that the contents of the individual elements may fall in the ranges specified above in the target complex compound. The slurry or solution thus prepared is dried and subsequently fired in the ambient atmosphere at 300° C. to 900° C. for at least one minute and at most six hours to obtain the complex compound mentioned above.

Then, the complex compound consequently obtained is pulverized by the use of a jet pulverizer or by means of milling, for example, till the average particle diameter reaches below the diameter of the short fibers of the metal fibers to be used and below 20 μm as well. The pulverized particles of the complex compound thus obtained are dispersed in a solvent, such as water, to prepare slurry. Alternatively, the pulverized particles of the complex compound and a binder optionally added thereto are together mixed with a solvent, such as water, so as to acquire proper viscosity and prepare slurry. As the binder, silica sol or alumina sol may be preferably used. The metal fibers are coated with the slurry thus prepared and the coated metal fibers are subsequently dried and fired to produce the nitride oxides-removing material of this invention.

The complex compound, when the short fibers of the metal fibers to be used happen to have a diameter greater than 20 μm, is preferably pulverized till the average particle diameter of the resultant particulates falls below 20 μm. When slurry of the particulates of the complex compound is to be prepared, the particulates that have an average particle diameter of 20 μm or less bring about satisfactory dispersibility in the slurry and permit manufacture of homogeneous slurry. At the same time, the particulates can be fixed in a stabilized state onto the surfaces of the metal fibers. If the particulates of the complex compound have an average particle diameter exceeding 20 μm, the overage will possibly result in preventing the object of this invention from being attained as expected by depriving the particulates in the slurry of the uniform dispersibility and disposing them to peel off readily from the surfaces of the metal fibers.

The manufacture of the particulates of the complex compound into the slurry is preferred to be carried out so that the concentration of the particulates in the slurry may fall in the range of 30 weight % to 70 weight %. As the means to coat the metal fibers with the slurry, a method which comprises immersing the metal fibers in the slurry, lifting them up and drying the wet metal fibers, a method which comprises directly applying the slurry to the metal fibers, and a method which comprises directly spraying the slurry to the metal fibers are available. These methods may be carried out either singly or properly combined. When the surfaces of metal fibers are to be coated with the particulates of the complex compound, though the coating may cover the surfaces of the metal fibers either wholly or partly, it is preferred that the particulates of the complex compound form a uniform coat on the surfaces of the metal fibers.

The content of the complex compound in the nitrogen oxides-removing material of this invention is preferred to be in the range of 0.1 to 50 weight %. If this content falls short of 0.1 weight %, the shortage will result in preventing the inherent effect of this invention from being manifested fully. If the content exceeds 50 weight %, the overage will bring no proportionate addition to the effect and therefore prove wasteful.

The nitrogen oxides-removing material of this invention can be produced by another method of production, besides the method enumerated above. To be specific, the nitrogen oxides-removing material contemplated by this invention can be obtained by the method comprising wet-mixing the particulates of a compound containing the elements, such as Group VIII elements, Group IX elements or Group X elements, with a binder containing at least one of Group I elements of the periodic table of the elements, at least one of Group II elements of the periodic table of the elements, at least one of Group XIII elements of the periodic table of the elements and at least one of Group XIV elements of the periodic table of the elements, thereby preparing a slurry, coating the surfaces of metal fibers with the slurry, drying the metal fibers, and subsequently firing them in the air at a temperature in the range of 300° C. to 900° C.

The binder to be used in the method of production described above is obtained by preparing an alkali metal element, an alkaline earth metal element, a Group III-B element and a Group IV-B element each in the form of an oxide, a nitrate, a sulfate or a carbonate and compounding the salts thus prepared and a commercially available silica sol or alumina sol in properly adjusted amounts such that the contents of the individual elements in the target complex compound may fall in the relevant ranges mentioned above.

The complex compound of which the nitrogen oxides-removing material of this invention is formed is used particularly advantageously when it is so prepared that it may acquire a configuration having the lattice spacing (d value) in the powder X-ray diffraction in at least any one of the ranges (1) 4.72 to 5.28 Å, (2) 3.39 to 3.66 Å, (3) 3.19 to 3.43 Å, (4) 3.03 to 3.24 Å, (5) 2.79 to 2.97 Å, (6) 2.46 to 2.60 Å, (7) 2.18 to 2.28 Å, (8) 1.99 to 2.08 Å, (9) 1.85 to 1.92 Å, (10) 1.66 to 1.71 Å, (11) 1.56 to 1.61 Å, (12) 1.49 to 1.53 Å, (13) 1.43 to 1.46 Å and (14) 1.28 to 1.31 Å.

The metal fibers onto which the complex compound is fixed are preferred to be stainless steel fibers. The stainless steel fibers which are particularly advantageously used contain iron in an amount of 50 weight % or more and, at the same time, contain at least one metal selected from the group consisting of nickel, chromium, carbon, silicon, manganese, phosphorus, sulfur, molybdenum, aluminum, nitrogen, selenium, copper, titanium, niobium and zirconium.

The nitrogen oxides-removing material contemplated by this invention can be used in its unmodified form. It may be optionally used as molded by using or not using a commercially available binder in a definite form of bulk, pellets, honeycombs or felt each in a spherical, cylindrical or polygonal shape. Otherwise, the nitrogen oxides-removing material of this invention may be tentatively pulverized in a powdery state and subsequently molded in a fixed form by using the ordinary procedure or deposited in the form of a coat on a supporting structure. As concrete examples of the supporting structure, the carrier bases made of ceramic substances, such as cordierite, titania, zirconia, zeolite and alumina, and the carrier bases made of metals, such as stainless steel, may be cited.

Now, the embodiment of the nitrogen oxides-removing material of this invention will be described below. This purifying device comprises an oxide purifying material of this invention and a temperature elevating means for heating the nitrogen oxides-removing material to a temperature of 100° C. or more. Even when the nitrogen oxides-removing material suffers the function thereof to be lowered in consequence of a prolonged continuous service for purification, it can recover the function using the temperature elevating means to heat the nitrogen oxides-removing material. Incidentally, the recovery of the function of the nitrogen oxides-removing material may be accomplished by providing the nitrogen oxides-removing device with a means to control the temperature of the exhaust gas of combustion being introduced into the nitrogen oxides-removing device in the range of 300 to 900° C. either in the place of the temperature elevating means mentioned above or in combination with this temperature elevating means.

As regards the nitrogen oxides-removing device of this invention, the idea of disposing the means to decrease the concentration of oxygen contained in the exhaust gas of combustion being introduced into this nitrogen oxides-removing device on the upstream side of the nitrogen oxides-removing material constitutes a preferred embodiment. The means to decrease the concentration of oxygen contained in the exhaust gas of combustion is highly effective in removing the nitrogen oxides in the exhaust gas of combustion and consequently detoxifying the exhaust gas because it can manifest the function of removing nitrogen oxides even when the exhaust gas of combustion happens to contain oxygen excessively. As the means to decrease the concentration of oxygen contained in the exhaust gas of combustion, a combustion exhaust gas passageway having fine titanium particles fixed which is disposed on the upstream side of the nitrogen oxides-removing material proves preferable.

Now, this invention will be described more specifically below with reference to examples. It should be noted, however, that this invention is not limited to these examples.

### EXAMPLE 1

(1) Preparation of slurry of complex compound: SrCO₃ (powder 99.99%) and RuO₂ (powder 99.9%) were added at a molar ratio of 2:1, mixed thoroughly while continuously pulverized in an agate mortar, and sintered in the air at 900° C. for 6 hours. The resultant sinter was again pulverized and mixed and again sintered in the air at 1200° C. for 6 hours to afford a powdered oxide. The powdered oxide and a powdered binder composed of silicon oxide, sodium oxide, calcium oxide and boron oxide were added at a weight ratio of 1:1 and mixed while pulverized fully finely in an agate mortar. Then, the resultant powdered mixture composed of the powdered oxide and the powdered binder was made to add water at a (powdered mixture):(water) weight ratio of 20:10 and suspended thoroughly in the added water to prepare slurry of complex compound.

(2) Manufacture of nitrogen oxides-removing material: A stainless steel wool having an iron content of 70 weight %, a nickel content of 8 weight % and a chromium content of 18 weight % was prepared. When this stainless steel wool was tested for specific electric resistance at about 25° C. with a commercially available tester, the magnitude was found to be 0.01 Ωcm or less. The slurry prepared above was uniformly applied to the whole surface of the stainless steel wool. Then, this stainless steel wool was sintered in the air at 860° C. for 10 minutes to obtain the nitrogen oxides-removing material contemplated by this invention.

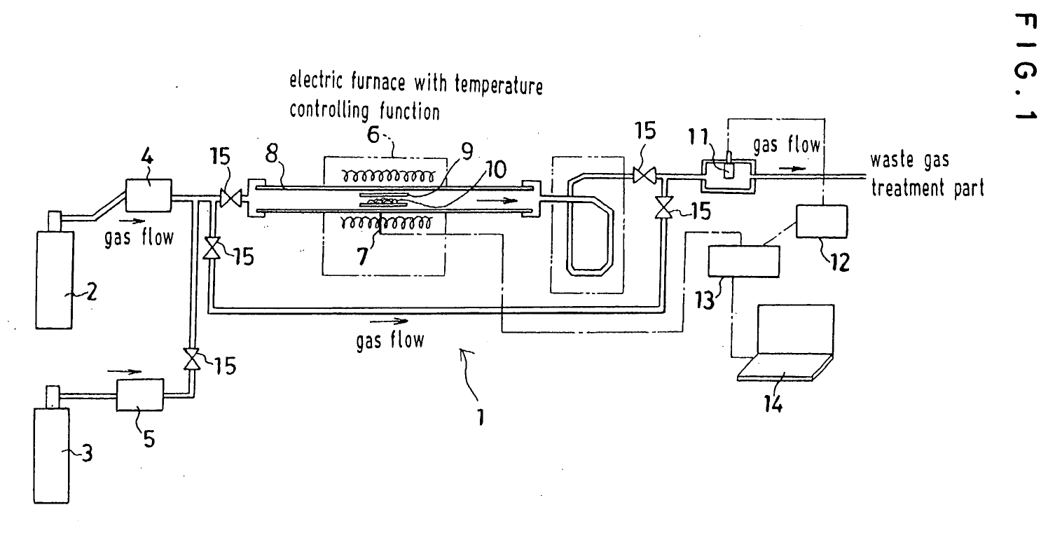

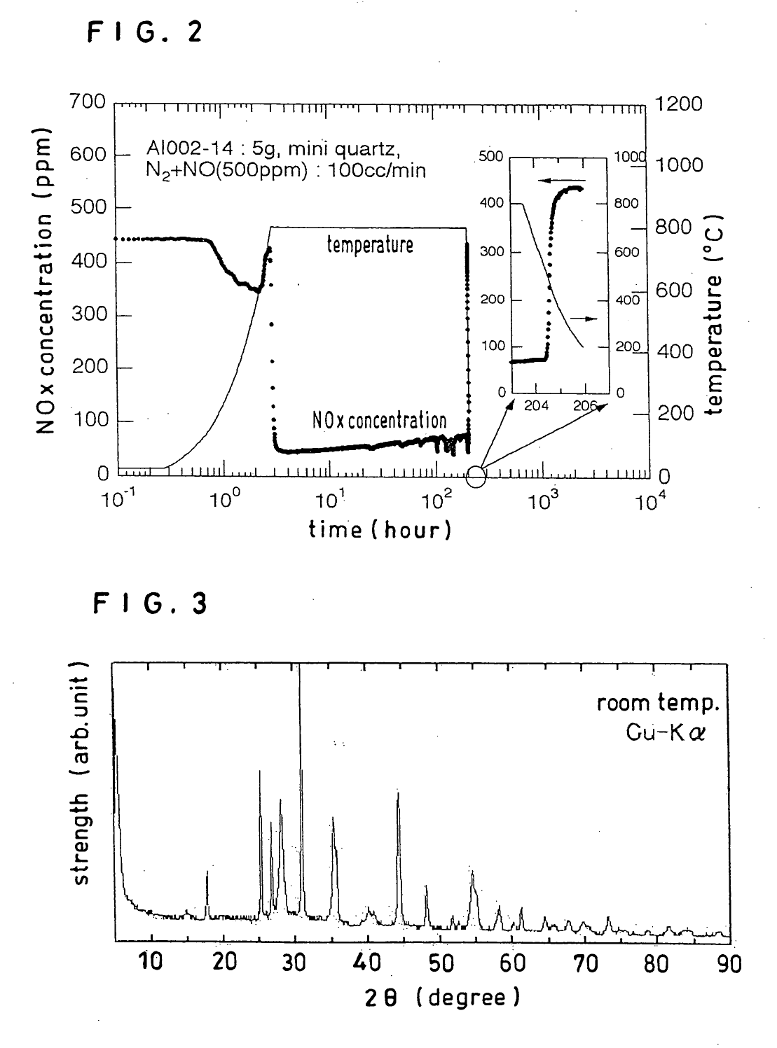

(3) Test 1 for evaluating capacity for removal of nitrogen oxides: First, an evaluating system 1 configured as illustrated in FIG. 1 was prepared. At the center of an electric furnace 6 with a temperature controlling function constituting this evaluating system 1, a tubular quartz glass 8 (measuring 1000 mm in length and 21 mm in inside diameter) was disposed so as to control the temperature of the neighborhood. At the center of this tubular quartz glass 8, a miniature quartz tube 9 (measuring 100 mm in length, 16 mm in inside diameter, and 20 mm in outside diameter) was installed. The miniature quartz tube 9 was intended to prevent a sample from reacting with the quartz glass 8 and was connected to cylinders 2 and 3 via gas flow rate controlling meters 4 and 5. The gases introduced from the cylinders 2 and 3 had their flow rates controlled by the gas flow rate controlling meters 4 and 5 and were introduced into the miniature quartz tube 9 and brought into contact with a sample subjected to the evaluation of performance. After 5 g of the nitrogen oxides-removing material of Example 1 was placed in the miniature quartz tube 9 held inside the electric furnace 6 of FIG. 1 with the temperature controlling function and 500 ppm of nitrogen oxide diluted with nitrogen gas (N₂) was introduced as controlled to a flow rate of 0.1 liter/minute into the miniature quartz tube 9 controlled to a prescribed temperature. The hot gas emanating from the tubular quartz glass 8 was cooled with water across a stainless steel pipe of a gas flow path and the cooled gas was tested for the concentration of nitrogen oxides in the gas with a sensor 11 and a nitrogen oxides tester 12 (made by Horiba Manufactory K.K.). The results are shown in FIG. 2. From the results of FIG. 2, the nitrogen oxides-removing material of Example 1 started the removal of NOₓ at a temperature of 150° C. and maintained the effect of substantially completely removing NOₓ for 200 hours or more at a treating temperature of 800° C., indicating that the nitrogen oxides-removing material of Example 1 possessed a sufficient ability to remove nitrogen oxides.

(4) X-ray diffraction measurement: The stainless steel wool was removed from the nitrogen oxides-removing material of Example 1 and the complex compound fixed onto the stainless steel wool was exclusively recovered. The recovered complex compound was thoroughly pulverized in an agate mortar till it formed fine particles having a homogenous particle diameter. Then, the complex compound transformed into the fine particles was uniformly fixed onto a glass plate designed for the measurement of X-ray diffraction by means of a double-sided adhesive tape. Then, this glass plate was set in a powder X-ray diffraction device and tested for X-ray diffraction in a range of 2θ from 5° through 90° by using a Cu—KαX-ray. The results of this test are shown in FIG. 3. From FIG. 3, it is known that that the complex compound forming the nitrogen oxides-removing material of Example 1 had high peak strengths when at least the 2θ was between 30° and 32°, between 34° and 36° and between 43° and 45°. When the peaks are expressed in terms of the d value (Å) of the respective lattice spacings in connection with Bragg diffraction condition, 2d·sin θ=nλ, (n: an integer), since the wavelength λ of the X ray of Cu—Kα is 1.5418 Å, the lattice spacings of the complex compound of Example 1 were (1) 3.4 to 3.7 Å, (2) 2.8 to 3.0 Å, (3) 2.5 to 2.6 Å and (4) 2.0 to 2.1 Å, respectively.

### COMPARATIVE EXAMPLE 1

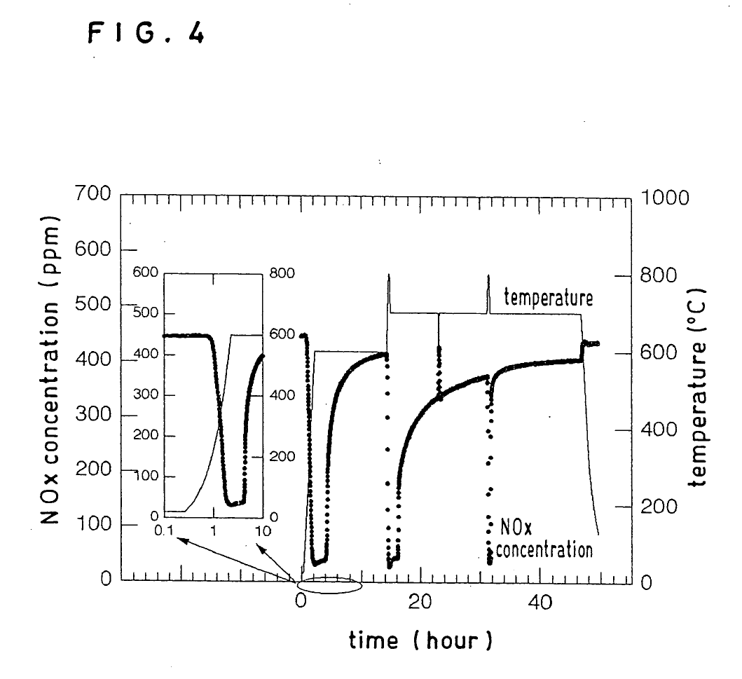

Five (5) g of the stainless steel wool forming the nitrogen oxides-removing material of Example 1 was prepared and it was used as a sample of Comparative Example 1. The sample of Comparative Example 1 was tested for evaluation of the performance of removing nitrogen oxides by following the procedure of Example 1 while carrying out an operation of maintaining the electric furnace 6 with a temperature controlling function constantly at 600° C. and 700° C. and performing a heating treatment at 800° C. for 10 minutes up to several repetitions. The results are shown in FIG. 4. From FIG. 4, it is seen that the removal of NOx was started at 180° C., the removal of NOₓ was substantially completed at 500° C., and this effect was lost within an extremely short time.

### EXAMPLE 2

RuO₂ (powder 99.9%) and the powdered binder formed of silicon oxide, sodium oxide, calcium oxide and boron oxide and used in Example 1 were mixed in a weight ratio of 1:1 and the resultant mixture was thoroughly mixed while continuously pulverized in an agate mortar. Then, the powdered mixture formed of the powdered oxide and the powdered binder was thoroughly suspended in water added thereto in an amount satisfying a weight ratio of (powdered mixture):(water)=20:10 to prepare slurry of a complex compound. Separately, the stainless steel wool used in Example 1 was prepared. The slurry was applied homogeneously to the whole stainless steel wool. Subsequently, the stainless steel wool coated with the slurry was sintered in the air at 860° C. for 10 minutes to obtain a nitrogen oxides-removing material of Example 2.

### EXAMPLE 3

Pt (powder 99.9%) and the powdered binder formed of silicon oxide, sodium oxide, calcium oxide and boron oxide and used in Example 1 were mixed at a weight ratio of 1:1 and the resultant mixture was thoroughly mixed while continuously pulverized in an agate mortar. A nitrogen oxides-removing material of Example 3 was manufactured by following the procedure of Example 2 while changing the conditions excepting the composition of a starting substance.

### EXAMPLE 4

SrCO₃ (powder 99.99%) and Pt (powder 99.9%) were added at a molar ratio of 4:1 and thoroughly mixed while continuously pulverized in an agate mortar. Then, a nitrogen oxides-removing material of Example 4 was manufactured by following the procedure of Example 1 while changing the conditions excepting the composition of a starting substance.

### COMPARATIVE EXAMPLE 2

The powdered binder formed of silicon oxide, sodium oxide, calcium oxide and boron oxide and used in Example 1 was thoroughly suspended in water added thereto in an amount satisfying a weight ratio of (powdered binder):(water)=20:10 to manufacture slurry. Separately, the stainless steel wool used in Example 1 was prepared. The slurry was homogeneously applied to the whole stainless steel wool. Subsequently, this stainless steel wool was sintered in the air at 860° C. for 10 minutes to obtain a nitrogen oxides-removing material of Comparative Example 2.

Test 2 for evaluation of removal of nitrogen oxides: In the case of effecting the reaction with a nitrogen oxides-containing nitrogen fed at a larger flow rate than in the Test 1 for the evaluation of the capacity for the removal of nitrogen oxides, the nitrogen oxides-removing materials of Examples 1 to 4 and Comparative Example 2 were tested for the capacity for removing NOₓ in the nitrogen oxides-containing nitrogen fed at the larger flow rate mentioned above.

For the purpose of evaluating the performance of removing NOₓ in the nitrogen oxides-containing nitrogen fed at a high flow rate with respect to the examples and the comparative example mentioned above, the following system was prepared. In the evaluating system 1 configured as illustrated in FIG. 1, the tubular quartz glass 8 and the miniature quartz tube 9 disposed therein were substituted with a cylindrical reaction vessel made of stainless steel (measuring 240 mm in length and 150 mm in inside diameter), the sensor 11 and the nitrogen oxides tester 12 were substituted with an NOₓ analyzer (made by Best Keiki K.K.) using the chemiluminescence method, and the cylindrical reaction vessel was connected to the NOₓ analyzer to complete the evaluation system.

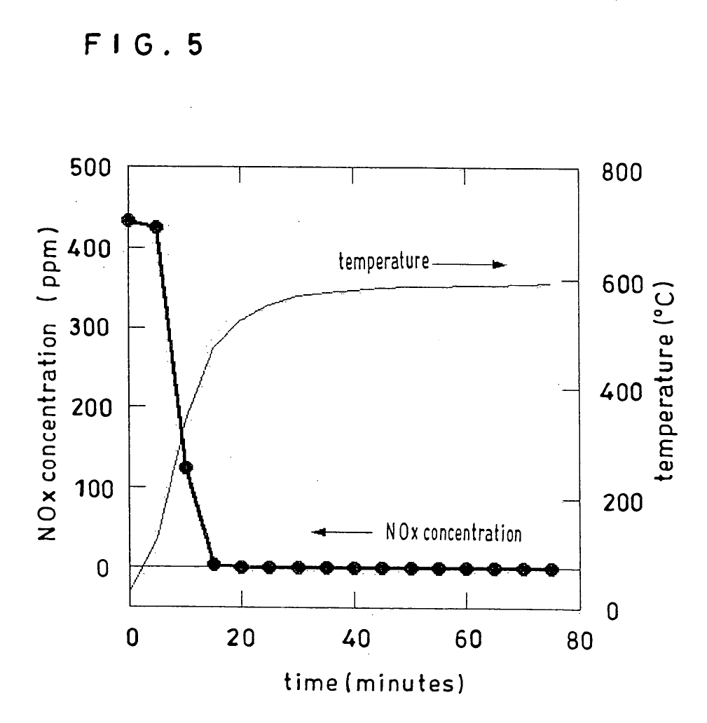

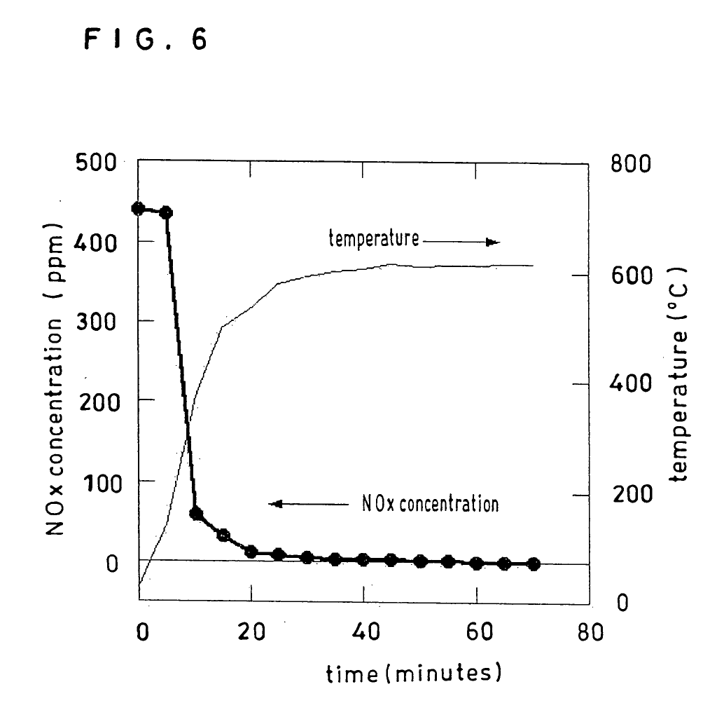

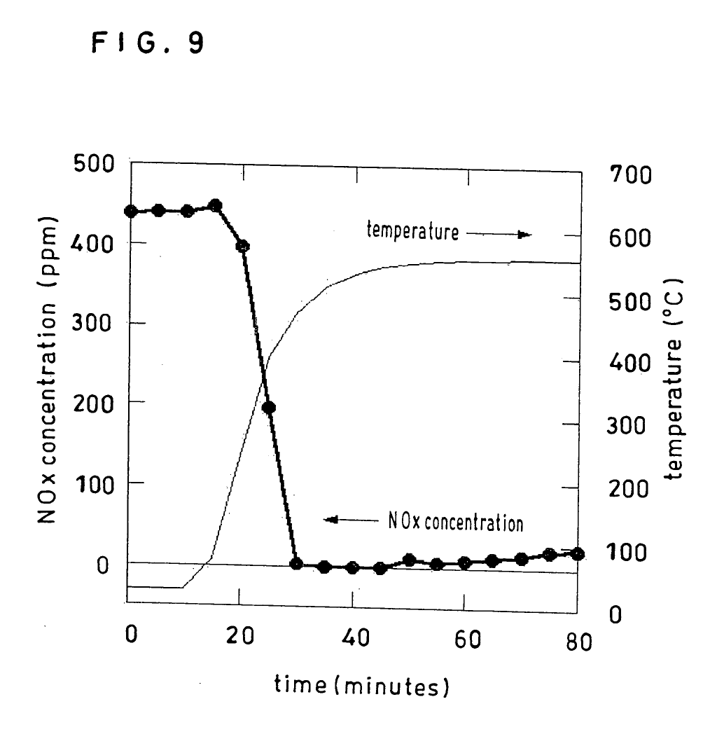

Then, 1000 g of a sample subjected to the evaluation was placed substantially at the center of the reaction vessel. Subsequently, 430 ppm of nitrogen monoxide diluted with nitrogen gas (N₂) was introduced as controlled to a flow rate of 1.0 liter/min into the reaction vessel controlled to a prescribed temperature. The hot gas emanating from this reaction vessel was cooled with water across the stainless steel pipe of a gas flow path. The cooled gas was tested for the NOₓ concentration with the NOₓ analyzer. By the method described above, the samples of the nitrogen oxides-removing materials of Examples 1 to 4 and comparative Example 2 were tested for the capacity for removing NOₓ. The results of this test are shown in FIGS. 5 to 9.

It is found from the results of FIG. 5 that the nitrogen oxides-removing material of Example 1 began the removal of NOₓ at a temperature of about 200° C. and completed the removal of NOₓ at about 460° C. in spite of increasing the flow rate of the nitrogen oxides-containing nitrogen to about 10 times the flow rate used in Test 1 for evaluating the capacity for removing nitrogen oxides.

The nitrogen oxides-removing material of Example 2 is found from the results of FIG. 6 that it began the removal of NOₓ at a temperature of about 250° C. and completed the removal of NOₓ at about 600° C. in spite of increasing the flow rate of the nitrogen oxides-containing nitrogen to about 10 times the flow rate used in Test 1 for evaluating the capacity for removing nitrogen oxides.

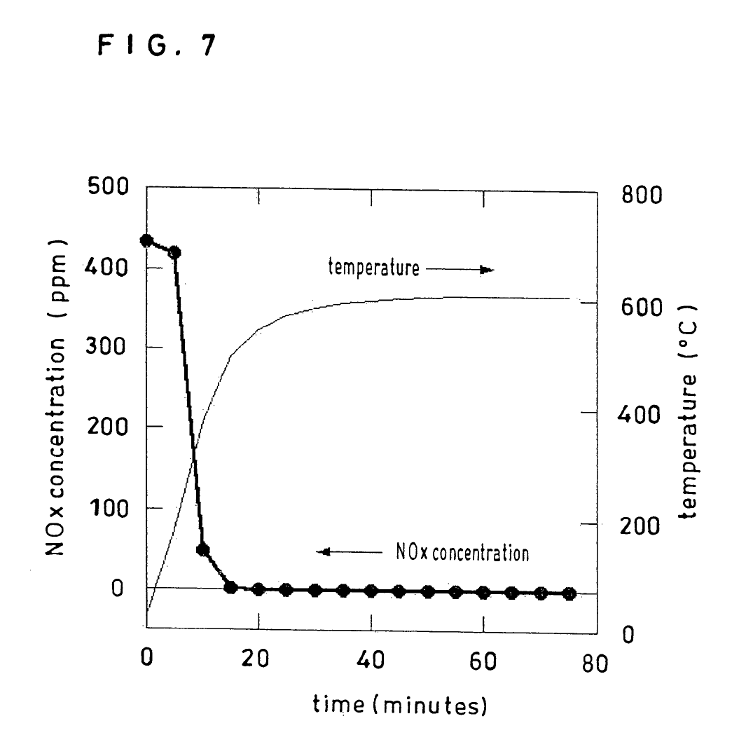

The nitrogen oxides-removing material of Example 3 is found from the results of FIG. 7 that it began the removal of NOₓ at a temperature of about 280° C. and completed the removal of NOₓ at about 480° C. in spite of increasing the flow rate of the nitrogen oxides-containing nitrogen to about 10 times the flow rate used in Test 1 for evaluating the capacity for removing nitrogen oxides.

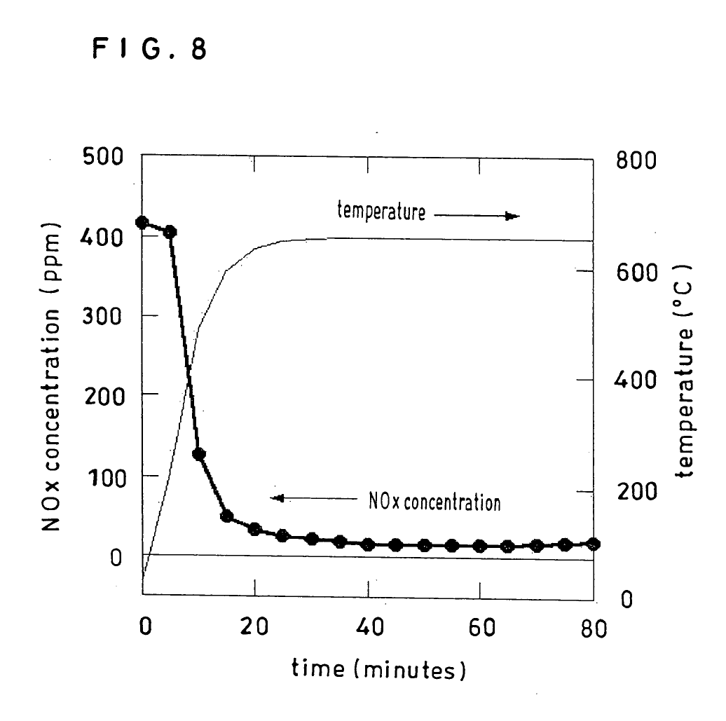

The nitrogen oxides-removing material of Example 4 is found from the results of FIG. 8 that it began the removal of NOₓ at a temperature of about 350° C. and completed the removal of NOₓ at about 650° C. in spite of increasing the flow rate of the nitrogen oxides-containing nitrogen to about 10 times the flow rate used in Test 1 for evaluating the capacity for removing nitrogen oxides. The preceding results demonstrate that the nitrogen oxides-removing materials of this invention obtained in Examples 1 to 4 exhibit excellent effects of removing NOₓ from the nitrogen oxides-containing nitrogen fed at a high flow rate.

In contrast, the nitrogen oxides-removing material of Comparative Example 2 began the removal of NOₓ at a temperature of about 240° C. and completed the removal of NOₓ at about 500° C. and nevertheless began to lose the effect within about 20 minutes of beginning the removal. These results indicate that the nitrogen oxides-removing material of Comparative Example 2 suffered the effect of removing nitrogen oxides to be lost within an extremely short time as compared with the samples of Examples 1 to 4.

The following experiment was carried out with the object of deciding the question of what effects titanium (Ti) would manifest to the combustion gas containing oxygen excessively.

(1) Preparation of Ti-fixed filtering material: Ti (powder 99.9%) and the powdered binder formed of silicon oxide, sodium oxide, calcium oxide and boron oxide and used in Example 1 were added at a weight ratio of 1:1 and thorough mixed while continuously pulverized in an agate mortar. A filtering material having Ti fixed onto the surface thereof was obtained by following the procedure of Example 2 while changing the conditions excepting the composition of a starting substance.

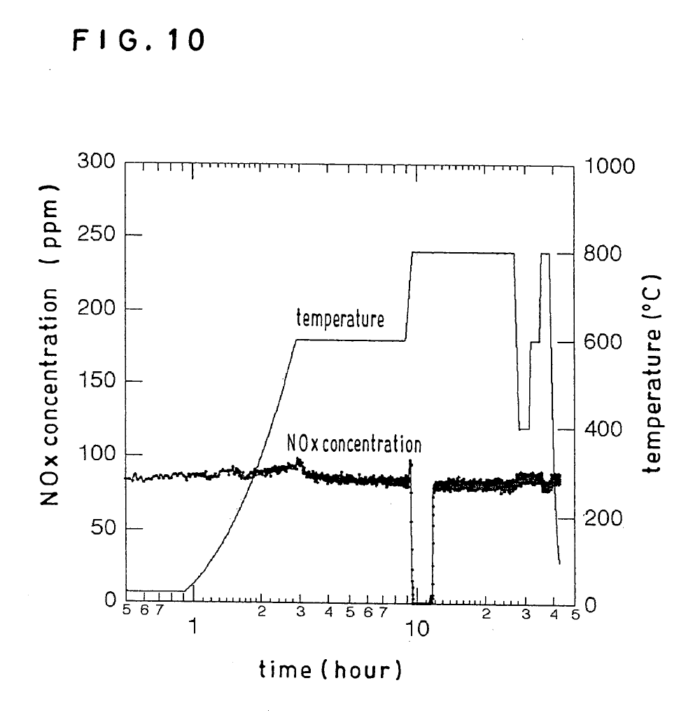

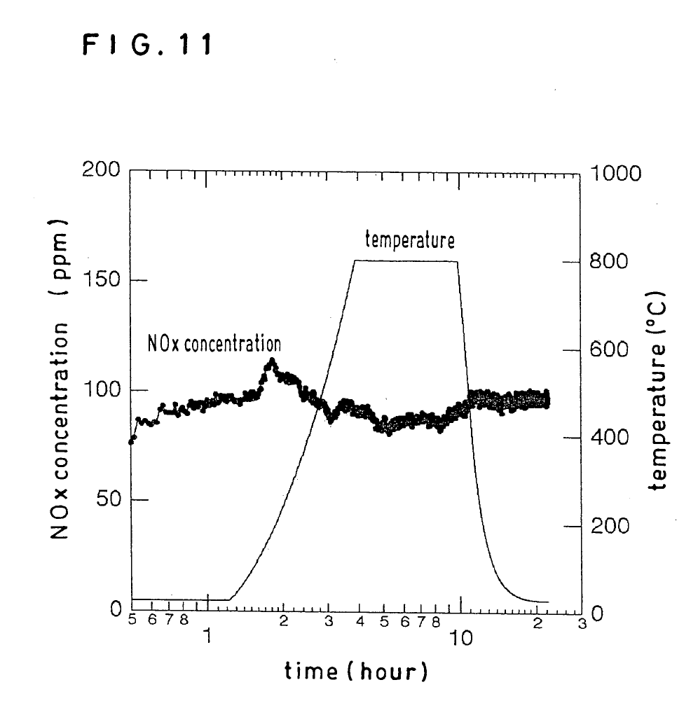

(2) Test for evaluating the capacity for removing nitrogen oxides in the presence of oxygen: Five (5) g of the Ti-fixed filtering material and 15 g of the nitrogen oxides-removing material of Example 1 were individually prepared. The filtering material and nitrogen oxides-removing material were placed in the miniature quartz tube 9 of the evaluation device 1 illustrated in FIG. 1 so that the Ti-fixed filtering material is disposed on the upstream side of the nitrogen oxide purifying material. Separately prepared were a cylinder packed with nitrogen monoxide diluted with nitrogen gas and a cylinder packed with oxygen gas. The gases from these cylinders were mixed in amounts giving rise to an oxygen concentration in the range of 0 to 2% and the resultant mixed gas was introduced as controlled to a flow rate of 0.1 litter/min into the miniature quartz tube 9 controlled in advance to a prescribed temperature. The hot gas emanating from the tubular quartz glass 8 was cooled with water across the stainless steel pipe of the gas flow path and the cooled gas was tested for the concentration of nitrogen oxides in the gas with the nitrogen oxides tester 11. Incidentally, the temperature of the electric furnace was retained at fixed temperatures of 600° C. and 800° C. The results are shown in FIG. 10. An experiment was carried out by following the procedure just described while avoiding the use of the Ti-fixed filtering material. The results are shown in FIG. 11.

From the results of FIG. 10, the removal of NOₓ was started at 750° C. and substantially completed at 800° C. even in the combustion gas containing oxygen excessively. Meanwhile, it is noted from the data of FIG. 11 that the NOₓ in the combustion gas containing oxygen excessively was not removed appreciably when the use of the Ti-fixed filtering material was omitted. These results allow an inference that the material containing Ti possessed a mechanism for decreasing the concentration of oxygen and facilitating the removal of NOₓ.

### EXAMPLE 5

One thousand (1000) g of the nitrogen oxides-removing material of Example 1 was prepared and the reaction vessel was packed with the material. This reaction vessel was used for the removal of nitrogen. Separately, Ti (powder 99.9%) and a silicon-based high temperature-curing sealing material were added in a weight ratio of 1:1 and the resultant mixture was applied to the inner wall of a separate reaction vessel. This reaction vessel was used for the absorption of oxygen. The nitrogen oxides-removing device of Example 5 was manufactured by having the reaction vessel for the absorption of oxygen disposed in series on the upstream side of the reaction vessel for the removal of nitrogen.

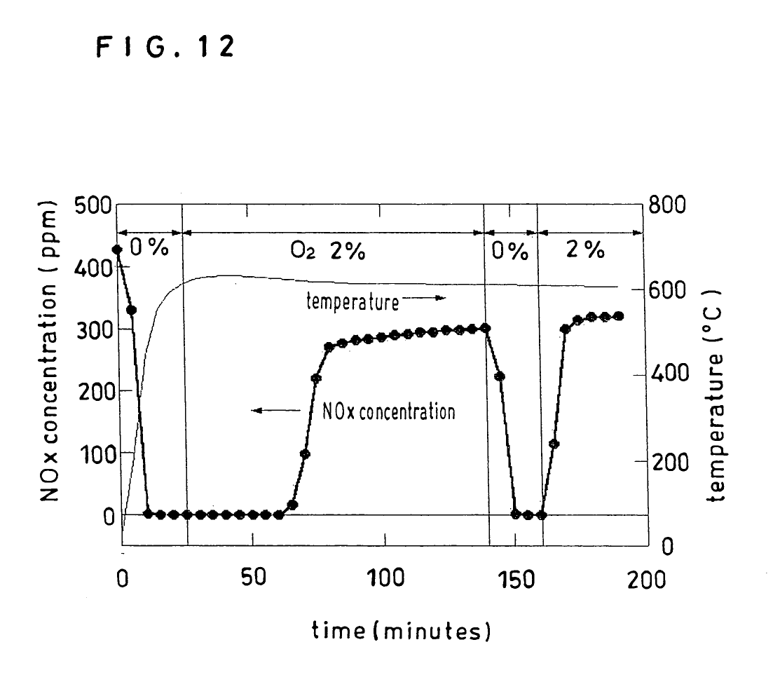

Test for evaluation of capacity for removal of nitrogen oxides in the presence of oxygen: The following system was prepared for the purpose of evaluating the nitrogen oxides-removing device of Example 5 for the performance of removing nitrogen oxides in the combustion gas containing oxygen excessively. In the evaluating system 1 configured as illustrated in FIG. 1, the tubular quartz glass 8 and the miniature quartz tube 9 disposed therein were substituted with the nitrogen oxides-removing device of Example 5, and the sensor 11 and the nitrogen oxides tester 12 were substituted with a NOₓ analyzer (made by Best Keiki K.K.) using the chemiluminescence method to complete the evaluation system. Then, prepared were a cylinder packed with nitrogen monoxide diluted with nitrogen gas and a cylinder packed with oxygen gas. The gases from these cylinders were mixed in amounts giving rise to an oxygen concentration in the range of 0 to 2%, and the resultant mixed gas was introduced into the nitrogen oxides-removing device of Example 5, with a flow rate controlled to 0.1 litter/min. The gas emanating from the reaction vessel for the removal of nitrogen was tested for the concentration of NOₓ contained in the gas. The concentration of NOₓ was measured while the temperature of the reaction vessel for the removal of nitrogen was varied. The results of this measurement are shown in FIG. 12.

It is noted from FIG. 12 that the removal of NOₓ was started at about 200° C. and completed at about 450° C. when the oxygen concentration was 0%. It is further noted that NOₓ could be perfectly removed within about 30 minutes of starting the removal even when the oxygen concentration was increased to 2%. The ratio of NOₓ removal subsequently fell. It is noted, however, that NOₓ could be completely removed when the oxygen concentration was lowered again to 0%. Thus, the nitrogen oxides-removing device of Example 5 was excellent in the ability to remove nitrogen oxides in the combustion gas containing oxygen excessively.

What is claimed is:

1. A nitrogen oxides-removing material having fixed onto surfaces of metal fibers a complex compound containing at least one element selected from the group consisting of Group VIII elements, Group IX elements and Group X elements in the periodic table of the elements and at least one element selected from the group consisting of Group I elements, Group II elements, Group XIII elements and Group XIV elements in the periodic table of the elements.

2. A nitrogen oxides-removing material according to claim 1, wherein the complex compound contains at least one element selected from the group consisting of Group VIII elements, Group IX elements and Group X elements in the periodic table of the elements, at least one of Group I elements in the periodic table of the elements, at least one of Group II elements in the periodic table of the elements, at least one of Group XIII elements in the periodic table of the elements and at least one of Group XIV elements in the periodic table of the elements.

3. A nitrogen oxides-removing material according to claim 1 or claim 2, wherein the at least one element selected from the group consisting of Group VIII elements, Group IX elements and Group X elements is in a form of fine particles and wherein the at least one of Group I elements, at least one of Group I elements, at least one of Group XIII elements and at least one of Group XIV elements are contained in a binder, the nitrogen oxides-removing material being obtained by a method comprising wet-mixing the fine particles with the binder to prepare slurry, coating the surfaces of the metal fibers with the slurry, drying the metal fibers and firing the metal fibers in the air at a temperature in the range of 300° C. to 900° C.

4. A nitrogen oxides-removing material according to claim 1 or claim 2, wherein the complex compound has a lattice spacing (d value) in a powder X ray diffraction in any one of ranges (1) 4.72 to 5.28 Å, (2) 3.39 to 3.66 Å, (3) 3.19 to 3.43 Å, (4) 3.03 to 3.24 Å, (5) 2.79 to 2.97 Å, (6) 2.46 to 2.60 Å, (7) 2.18 to 2.28 Å, (8) 1.99 to 2.08 Å, (9) 1.85 to 1.92 Å, (10) 1.66 to 1.71 Å, (11) 1.56 to 1.61 Å, (12) 1.49 to 1.53 Å, (13) 1.43 to 1.46 Å and (14) 1.28 to 1.31 Å.

5. A nitrogen oxides-removing material according to claim 1 or claim 2, wherein the metal fibers are made of a stainless steel alloy.

6. A nitrogen oxides-removing material according to claim 3, wherein the metal fibers are made of a stainless steel alloy.

7. A nitrogen oxides-removing material according to claim 1 or claim 2, which is in a form of bulk, honeycombs, felt or powder.

8. A nitrogen oxides-removing material according to claim 3, which is in a form of bulk, honeycombs, felt or powder.

9. A nitrogen oxides-removing material according to claim 4, which is in a form of bulk, honeycombs, felt or powder.

10. A nitrogen oxides-removing device comprising the nitrogen oxides-removing material according to claim 1 or 2 and a means to elevate a temperature of the nitrogen oxides-removing material to than 100° C. or more.

11. A nitrogen oxides-removing device comprising the nitrogen oxides-removing material according to claim 3 and a means to elevate a temperature of the nitrogen oxides-removing material to than 100° C. or more.

12. A nitrogen oxides-removing device comprising the nitrogen oxides-removing material according to claim 4 and a means to elevate a temperature of the nitrogen oxides-removing material to than 100° C. or more.

13. A nitrogen oxides-removing device comprising the nitrogen oxides-removing material according to claim 5 and a means to elevate a temperature of the nitrogen oxides-removing material to than 100° C. or more.

14. A nitrogen oxides-removing device comprising the nitrogen oxides-removing material according to claim 6 and a means to elevate a temperature of the nitrogen oxides-removing material to than 100° C. or more.

15. A nitrogen oxides-removing device according to claim 10, further comprising a means to control a temperature of an exhaust gas of combustion introduced into the nitrogen oxides-removing device in a range of 300 to 900° C.

16. A nitrogen oxides-removing device according to claim 11, further comprising a means to control a temperature of an exhaust gas of combustion introduced into the nitrogen oxides-removing device in a range of 300 to 900° C.

17. A nitrogen oxides-removing device according to claim 12, further comprising a means to control a temperature of an exhaust gas of combustion introduced into the nitrogen oxides-removing device in a range of 300 to 900° C.

18. A nitrogen oxides-removing device according to claim 13, further comprising a means to lower a concentration of oxygen contained in an exhaust gas of combustion introduced into the nitrogen oxides-removing device, which means is disposed on an upstream side of the nitrogen oxides-removing material.

19. A nitrogen oxides-removing device according to claim 14, further comprising a means to lower a concentration of oxygen contained in an exhaust gas of combustion introduced into the nitrogen oxides-removing device, which means is disposed on an upstream side of the nitrogen oxides-removing material.

20. A nitrogen oxides-removing device according to claim 10, further comprising a means to lower a concentration of oxygen contained in an exhaust gas of combustion introduced into the nitrogen oxides-removing device, which means is disposed on an upstream side of the nitrogen oxides-removing material.

21. A nitrogen oxides-removing device according to claim 11, further comprising a means to lower a concentration of oxygen contained in an exhaust gas of combustion introduced into the nitrogen oxides-removing device, which means is disposed on an upstream side of the nitrogen oxides-removing material.

22. A nitrogen oxides-removing device according to claim 12, further comprising a means to lower a concentration of oxygen contained in an exhaust gas of combustion introduced into the nitrogen oxides-removing device, which means is disposed on an upstream side of the nitrogen oxides-removing material.

23. A nitrogen oxides-removing device according to claim 13, further comprising a means to lower a concentration of oxygen contained in an exhaust gas of combustion introduced into the nitrogen oxides-removing device, which means is disposed on an upstream side of the nitrogen oxides-removing material.

24. A nitrogen oxides-removing device according to claim 14, further comprising a means to lower a concentration of oxygen contained in an exhaust gas of combustion introduced into the nitrogen oxides-removing device, which means is disposed on an upstream side of the nitrogen oxides-removing material.

25. A nitrogen oxides-removing device according to claim 15, further comprising a means to lower a concentration of oxygen contained in an exhaust gas of combustion introduced into the nitrogen oxides-removing device, which means is disposed on an upstream side of the nitrogen oxides-removing material.

26. A nitrogen oxides-removing device according to claim 16, further comprising a means to lower a concentration of oxygen contained in an exhaust gas of combustion introduced into the nitrogen oxides-removing device, which means is disposed on an upstream side of the nitrogen oxides-removing material.

27. A nitrogen oxides-removing device according to claim 17, further comprising a means to lower a concentration of oxygen contained in an exhaust gas of combustion introduced into the nitrogen oxides-removing device, which means is disposed on an upstream side of the nitrogen oxides-removing material.

28. A nitrogen oxides-removing device according to claim 18, further comprising a means to lower a concentration of oxygen contained in an exhaust gas of combustion introduced into the nitrogen oxides-removing device, which means is disposed on an upstream side of the nitrogen oxides-removing material.

29. A nitrogen oxides-removing device according to claim 19, further comprising a means to lower a concentration of oxygen contained in an exhaust gas of combustion introduced into the nitrogen oxides-removing device, which means is disposed on an upstream side of the nitrogen oxides-removing material.

30. A nitrogen oxides-removing device according to claim 20, wherein the means to lower the concentration of oxygen contained in the exhaust gas of combustion is a combustion exhaust gas passageway having fine titanium particulates fixed thereon.

31. A nitrogen oxides-removing device according to claim 21, wherein the means to lower the concentration of oxygen contained in the exhaust gas of combustion is a combustion exhaust gas passageway having fine titanium particulates fixed thereon.

32. A nitrogen oxides-removing device according to claim 22, wherein the means to lower the concentration of oxygen contained in the exhaust gas of combustion is a combustion exhaust gas passageway having fine titanium particulates fixed thereon.

33. A nitrogen oxides-removing device according to claim 23, wherein the means to lower the concentration of oxygen contained in the exhaust gas of combustion is a combustion exhaust gas passageway having fine titanium particulates fixed thereon.

34. A nitrogen oxides-removing device according to claim 24, wherein the means to lower the concentration of oxygen contained in the exhaust gas of combustion is a combustion exhaust gas passageway having fine titanium particulates fixed thereon.

35. A nitrogen oxides-removing device according to claim 25, wherein the means to lower the concentration of oxygen contained in the exhaust gas of combustion is a combustion exhaust gas passageway having fine titanium particulates fixed thereon.

36. A nitrogen oxides-removing device according to claim 26, wherein the means to lower the concentration of oxygen contained in the exhaust gas of combustion is a combustion exhaust gas passageway having fine titanium particulates fixed thereon.

37. A nitrogen oxides-removing device according to claim 27, wherein the means to lower the concentration of oxygen contained in the exhaust gas of combustion is a combustion exhaust gas passageway having fine titanium particulates fixed thereon.

38. A nitrogen oxides-removing device according to claim 28, wherein the means to lower the concentration of oxygen contained in the exhaust gas of combustion is a combustion exhaust gas passageway having fine titanium particulates fixed thereon.

39. A nitrogen oxides-removing device according to claim 29, wherein the means to lower the concentration of oxygen contained in the exhaust gas of combustion is a combustion exhaust gas passageway having fine titanium particulates fixed thereon.
